(19) United States
(12) Patent Application Publication
(10) Pub. No.: US 2005/0216444 A1
(43) Pub. Date: Sep. 29, 2005

(54) Relationship-based searching

(76) Inventors: Gerd M. Ritter, Heidelberg (DE); Volkmar Stegmann, Altlussheim (DE)

Correspondence Address: FISH & RICHARDSON, P.C., PO BOX 1022, MINNEAPOLIS, MN, 55440-1022, US

(21) Appl. No.: 10/809,087

(22) Filed: Mar. 25, 2004

(51) Int. Cl. G06F 7/00

(52) U.S. Cl. 707/3

(57) ABSTRACT

One embodiment provides a method to retrieve information that contains name and relationship information. A computing system accepts input from a user to create a search request that contains a number of text characters. One or more of the text characters specify a name identifier, and one or more of the text characters specify a relationship to the name identifier. The computing system uses the search request to retrieve search results. Each search result contains the name identifier and also contains information representing the specified relationship to the name identifier. The computing system then displays to the user the name identifier for each search result in textual form.

### TECHNICAL FIELD

This invention relates to relationship-based searching in computing systems.

### BACKGROUND

In today's technology age, information and information sources are plentiful. On the World Wide Web, for example, individuals are capable of accessing many sorts of information from all over the world. Database and web servers may provide Internet users with information about fixing a car, critiquing a movie, buying products or services, and the like. In addition, various network or desktop application, such as email or business applications, may provide users with information about other users, business partners, contacts, and the like.

Because of the growing amount of data on the World Wide Web and in other data repositories, it often may be difficult for users to sort through the abundant amount of information provided as search output. Although a user may be able to enter a series of search terms in hopes of limiting the search, the user may still be presented with hundreds, or even thousands, of search results. In these types of situations, the user may be required to make additional selections, or to enter certain refinement criteria, to narrow down the set of search results.

For example, in one scenario, a user may wish to send an email message to a recipient named “John Smith”. If the user does not know the recipient's email address, the user may have to search for the address. To do so, the user could enter the term “John Smith” into a recipient field. A mail application could then search a database for all email addresses corresponding to recipients named “John Smith”. If “John Smith” is a common name, the mail application may receive multiple search results for recipients having this name. When these results are displayed, the user may need to scan through each of these results and select the appropriate recipient from the list according to additional information that is also shown. For example, the results may show both name and location information. After scanning through the results, the user may choose the “John Smith” located in Philadelphia. Upon selection, the mail application inserts the corresponding email address into the recipient filed of the message.

### SUMMARY

Various embodiments of the present invention are provided herein. One embodiment provides a method to retrieve information that contains name and relationship information. A computing system accepts input from a user to create a search request that contains a number of text characters. One or more of the text characters specify a name identifier, and one or more of the text characters specify a relationship to the name identifier. The computing system uses the search request to retrieve search results. Each search result contains the name identifier and also contains information representing the specified relationship to the name identifier. The computing system then displays to the user the name identifier for each search result in textual form.

Various embodiments of the invention may have certain benefits and advantages. For example, a user is able to narrow a set of search results, or more accurately identify a particular search result, by specifying both name and relationship information in a search request. By specifying this information in one search request, the user does not need to enter a series of manual selections in order to obtain a desired set of search results. In addition, the user is not required to specify the entire names of individuals, organizations, and the like. Instead, the user may specify as much of the name information as is known, along with the relationship information, in order to obtain the desired set of search results. As a result, the user interface is much less burdensome, and the user is capable of finding information easily and quickly.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a system that may be used for processing search information, according to one embodiment.

FIG. 1B is a block diagram of an alternate embodiment of the system shown in FIG. 1A.

FIG. 2 is a diagram of a search request format for the search requests used in FIG. 1A, according to one embodiment.

FIG. 3 is a diagram of a number of different examples of search requests having the format shown in FIG. 2.

FIG. 4 is a diagram of another example of a search request having the format shown in FIG. 2.

FIG. 5 through FIG. 9 are diagrams of various search results that may be retrieved upon processing of different search requests.

FIG. 10 is a block diagram of one component of the system shown in FIG. 1A or FIG. 1B, according to one embodiment.

### DETAILED DESCRIPTION

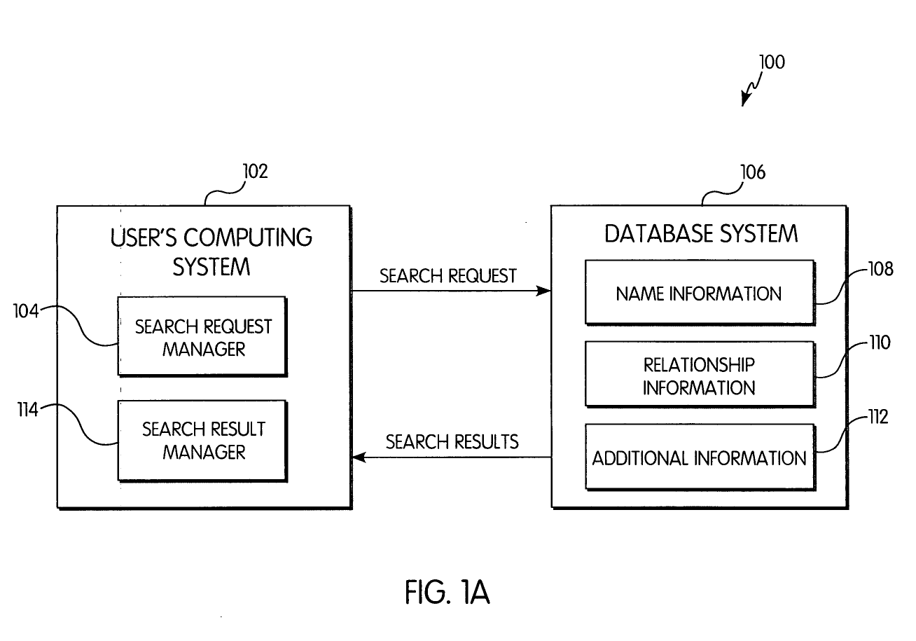

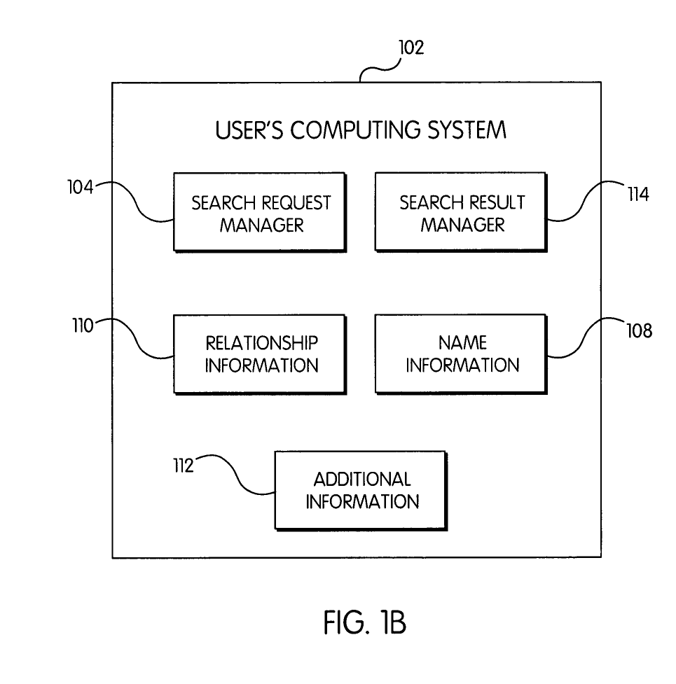

FIG. 1A is a block diagram of a system 100 that may be used, in general, for processing search information, according to one embodiment. In this embodiment, the system 100 includes a user's computing system 102 and an external database system 106. The user's computing system 102 is capable of retrieving information from the database system 106, which may be stored in a memory or a storage device. The database system 106 contains name information 108, relationship information 110, and additional information 112. During operation, the computing system 102 accepts input from a user and then uses a search request manager 104 to create a search request that contains text characters from the user's input. One or more of these text characters specify a name identifier, and one or more of these characters also specify a relationship, such as a business contact or location relationship, to the name identifier. The search request manager 104 sends the search request to the database system 106. The database system 106 uses the search request provided by the computing system 102 to obtain search results that each contain the specified name identifier and that also each contain information representing the specified relationship to the name identifier. To do so, the database system 106 accesses the name information 108, the relationship information 110, and the additional information 112 (if necessary). The database system 106 then provides the search results back to the computing system 102. A search result manager 114 in the computing system 102 processes these search results. The computing system 102 is then capable of utilizing a display device to display to the user the name identifier for each search result in textual form. In one embodiment, the computing system 102 is also capable of displaying to the user information representing the specified relationship to the name identifier for each search result in textual form.

The database system 106 is able to obtain the requested search results by using its name information 108, relationship information 110, and additional information 112 if necessary. The database system 106 accesses the relationship information 110 and the name information 108 to search for results having the specified relationship to the name identifier. In many situations, the database system 106 will access the additional information 112 when providing search results back to the search result manager 114 in the computing system 102. Examples of the types of information contained in these search results are provided in subsequent figures.

In some embodiments, the computing system 102 obtains from the user one or more text characters that specify the relationship to the name identifier. For example, the user may specify a particular relationship to the name identifier by providing specific text characters such as “@”, “is a contact of”, and the like. Subsequent figures describe the use of these characters in more detail. The computing system 102 can use these characters provided by the user when creating the search request that is sent to the database system 106. The database system 106 processes these specific text characters when accessing the relationship information 110.

In some embodiments, one or more of the text characters provided by the user specify a second name identifier. The search request manager 104 in the computing system 102 uses the second name identifier when creating the search request. For example, the search request may include the following characters: “Joe@SAP”. The first name identifier is “Joe”. The second name identifier is “SAP”. The relationship is “@”, which may stand for “is a contact of”. In various embodiments, the “@” character is used to represent a particular relationship, such as “is a contact of”. In this example, the computing system 102 initiates a request to search for an individual named “Joe” who is a contact person for the company “SAP”. The search request manager 104 sends the search request to the database system 106. The database system 106 uses this search request to retrieve search results that contain information having the specified relationship between the name identifier and the second name identifier. The database system 106 then sends these search results back to the search result manager 114 in the computing system 102.

When a user interacts with a software application running on the computing system 102, the user may initiate the search requests sent to the database system 106 to retrieve search results, according to some embodiments. For example, various different forms of software applications may be operable on the computing system 102, such as email application, calendar/appointment applications, customer service applications, and the like. When using these applications, a user is able to obtain a narrowed set of search results by specifying both name and relationship information in a search request. By specifying this information in one search request, the user does not need to enter a series of manual selections in order to obtain a desired set of search results from the database system 106.

FIG. 1B is a block diagram of an alternate embodiment of the user's computing system 102 shown in FIG. 1A. In the embodiment shown in FIG. 1B, the computing system 102 contains all of the name information 108, the relationship information 110, and the additional information 112, such as in a local database/storage system or in a local memory. In this embodiment, the computing system 102 processes the search requests and search results internally.

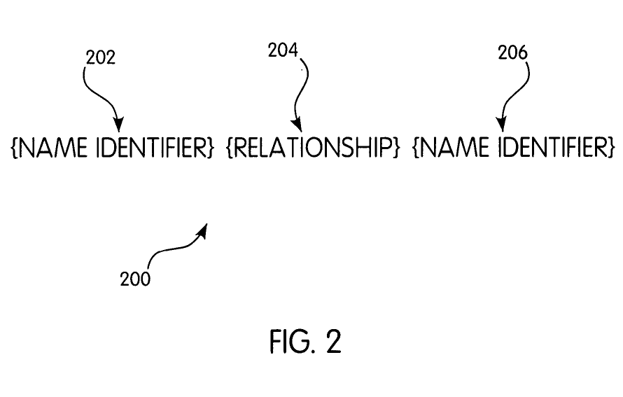

FIG. 2 is a diagram of a search request format 200 for the search requests used in FIG. 1A, according to one embodiment. Search requests using this format 200 include a first name identifier specified in a field 202, a relationship specified in a field 204, and a second name identifier specified in a field 206. Subsequent figures provide numerous examples of name identifiers and relationships that may be included within these fields 202, 204, and 206 in the format 200. The search request manager 104 in the computing system 102 creates search requests having the format 200 and, in the embodiment shown in FIG. 1A, sends these requests to the database system 106. The database system 106 then processes these search requests to identify the name identifiers and the relationship contained in the fields 202, 204, and 206. The database system 106 these accesses the name information 108, relationship information 110, and additional information 112 to identify search results that contain the name identifiers and relationship specified in the search requests, and then sends these results to the search result manager 114. In one embodiment, the database system 106 contains a mapping function to map relationship characters specified in the field 204 of search requests (e.g., “@”) to relationship identifiers contained within the relationship information 110 (e.g., “is a contact of”). The use of relationship characters will be shown and described in more detail in many of the subsequent figures.

In some embodiments, if the database system 106 does not contain any search results that have the relationship specified by the field 204 in a search request between the name identifier specified by the field 202 and the name identifier specified by the field 206, the database system 106 may then retrieve search results that include either the name identifier specified by the field 202 or the name identifier specified by the field 206. These search results will not necessarily contain information having a relationship specified by the field 204 of the search request, but will contain information relating to other name identifiers in the search request. For example, if the computing system 102 sends to the database system 106 a search request of “Joe@SAP” (wherein “@” represents a business contact relationship), the database system 106 may be unable to find any search results that include “Joe” as a business contact for the company “SAP”. Instead, the database system 106 may return to the computing system 102 all search results containing either the name identifier “Joe” or “SAP”.

In some embodiments, the name identifier specified by the field 202 or 206 in a given search request may be a personal name identifier (e.g., “Joe”), an organizational identifier (e.g., “SAP”), a location name identifier (e.g., “Germany”), or the like. The relationship specified by the field 204 of the search request may be a business contact relationship (e.g., “is a contact of”), a location relationship (e.g., “is located in”), or the like. In certain embodiments, the relationship specified by the field 204 may include one or more symbolic characters to represent the relationship. For example, the character “@” may be used to represent the relationship “is a contact of”.

In some embodiments, search requests using the format 200 include additional name identifiers and relationships (which are not shown in FIG. 2). The additional name identifiers and relationships are associated with additional fields similar to the fields 202, 204, and 206. By using search requests in this fashion, a user may specify additional information that can be used to obtain a more narrow set of search results. Subsequent figures and descriptions will provide examples of search requests having multiple name identifiers and relationships.

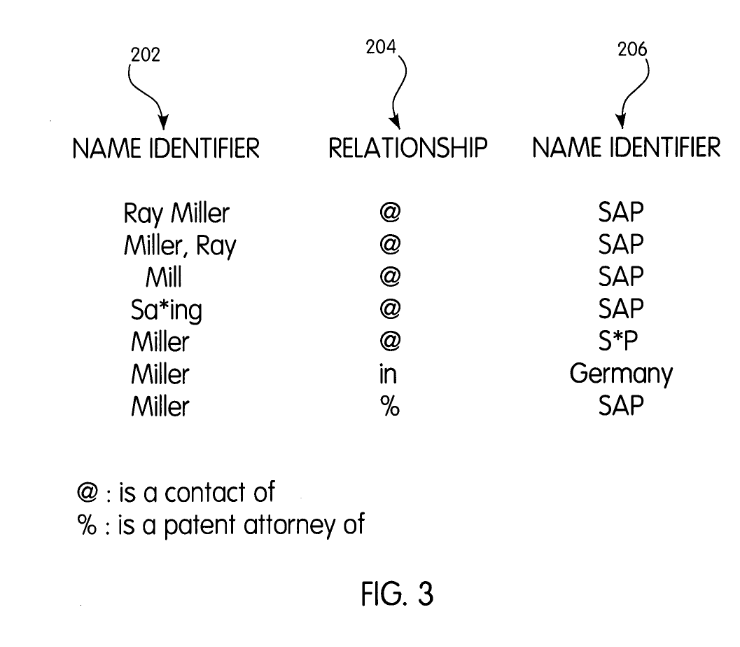

FIG. 3 is a diagram of a number of different examples of search requests having the format shown in FIG. 2. Each individual search request is shown in one row for the diagram in FIG. 3. In one embodiment, a user may directly enter the text characters for an individual search request by using a single input, or text-entry, field. The first search request that is shown contains the characters “Ray Miller@SAP”. In this example, “Ray Miller” is a personal name identifier contained within the field 202 of the search request, “@” is a relationship character contained within the field 204, and “SAP” is a organizational name identifier contained within the field 206. As shown in the legend, the “@” character specifies a relationship for “is a contact of”. As such, this search request sent by the computing system 102 to the database system 106 is requesting for any search results wherein “Ray Miller” is listed as a business contact of the company “SAP”.

The database system 106 will access its name information 108 to search for name identifiers corresponding to “Ray Miller” and “SAP”. The name information 108 may contain a first portion of personal name identifier information and a second portion of organizational name identifier information. If the name information 108 contain one or more matches for “Ray Miller” and “SAP”, the database system 106 will then access its relationship information 110 to search for business contact relationship information between the matches for “Ray Miller” and “SAP”. The relationship information 110 contains relationship information relating to the identifiers contained in the name information 108. If the relationship information 110 contains one or more matches for business contact relationships between identifiers “Ray Miller” and “SAP”, the database system 106 will collect these matches and prepare a set of corresponding search results. The search results will contain information from both the name information 108 and the relationship information 110 corresponding to the matches, and may also include other information associated with the matches from the additional information 112 (such as location information, telephone number information, and the like). The database system 106 then sends the set of search results back to the search result manager 114 in the computing system 102.

FIG. 3 provides many additional examples of search requests having the format shown in FIG. 2. One search request that is shown contains the characters “Miller, Ray@SAP”. This search request looks very similar to the one described above, except that the name identifier “Miller, Ray” in the field 202 provides a last name followed by a first name. The database system 106 is capable of processing name identifiers and relationships specified by search requests in many different formats. Both the search requests for “Ray Miller@SAP” and “Miller, Ray@SAP” would return one or more search results for individuals named “Ray Miller” who are business contacts of the company “SAP”. The database system 106 is able to access the name information 108 in searching for name identifiers in multiple different forms.

Another search request shown in FIG. 3 contains the characters “Mill@SAP”. Upon processing this search request, the database system 106 returns all search results for individuals whose names (first, last, middle, etc.) include “Mill” and who are business contacts for the company “SAP”. For example, the database system 106 could return search results containing names for “Ray Miller”, “Bob Miller”, “Joe Mills”, “Miller Davis,” etc., each of who are business contacts for “SAP”. In addition, the user is not required to specify the entire names of individuals, organizations, and the like. Instead, the user may specify as much of the name information as is known, along with the relationship information, in order to obtain the desired set of search results.

Search requests may also include wildcard characters. A user need not necessarily specify wildcard characters, but has the option of doing so if, for example, the user is not able to remember the full spelling of an individual's name. Two search requests shown in FIG. 3 contain wildcard characters. One search request shown in FIG. 3 contains the characters “Sa*ing@SAP”. Upon processing this request, the database system 106 may return results for individuals whose names are “Saykrning”, “Sasyuting”, etc., and who are business contacts for “SAP”. The user may then be able to identify the desired contact name from the results that are returned and displayed. Another search request contains the characters “Miller@S*P”. Upon processing this request, the database system 106 will return search results for individuals having the name “Miller” who are business contacts for companies such as “SAP”, “SSP”, “SLP”, or the like. The “*” character used in these search requests is a wildcard character. A user may specify a wildcard character to obtain a wider set of search results.

FIG. 3 also shows a few examples of search requests that have different types of relationships specified by the field 204. One search request contains the characters “Miller in Germany”. Upon processing this request, the database system 106 will return search results to the computing system 102 for individuals named “Miller” who are located in Germany. Another search request contains the characters “Miller % SAP”. According to the legend shown in FIG. 3, the relationship character “%” specifies a relationship for “a patent attorney of”. As such, upon processing this request, the database system 106 will return search results for individuals named “Miller” who are patent attorneys working for the company “SAP”.

In some embodiments, search requests may contain multiple relationships. For example, one search request may contain the characters “Miller@SAP in Germany”. By using multiple relationships and multiple name identifiers, a user may provide a more specific request for those individuals named “Miller” who are contacts for the company “SAP” and who are located in “Germany”.

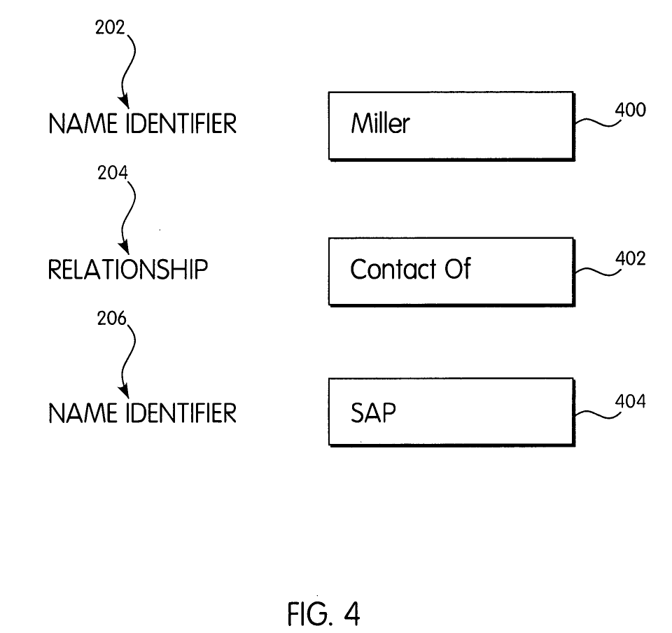

FIG. 4 is a diagram of another example of a search request having the format shown in FIG. 2. As shown in this example, a user is able to enter textual information into text fields 400, 402, and 404 to specify the name identifiers and relationship. In one embodiment, the text fields 400, 402, and 404 are displayed to a user via a graphical user interface (GUI). The text fields 400, 402, and 404 are associated with the search request fields 202, 204, and 206, respectively. When using the computing system 102, the user is able to enter a first name identifier of “Miller” into the text field 400, a relationship for “contact of” into the text field 402, and a second name identifier of “SAP” into the text field 404.

The search request manager 104 on the computing system 102 then is able to process the textual information contained within the text fields 400, 402, and 404 and create a search request having fields 202, 204, and 206, which is then routed to the database system 106. The search request manager 104 may directly populate the fields 202, 204, and 206 of the search request with the information contained in the text fields 400, 402, and 404, respectively. The search request manager 104 may, however, also make adjustments to or translate the information contained in the text fields 400, 402, and 404 entered by the user before populating the fields 202, 204, and 206 of the search request. For example, the search request manager 104 may translate the text “contact of” from the text field 402 into a “@” character that is placed within the field 204 of the search request. In this example, the “@” character is a representation of the relationship for “contact of”.

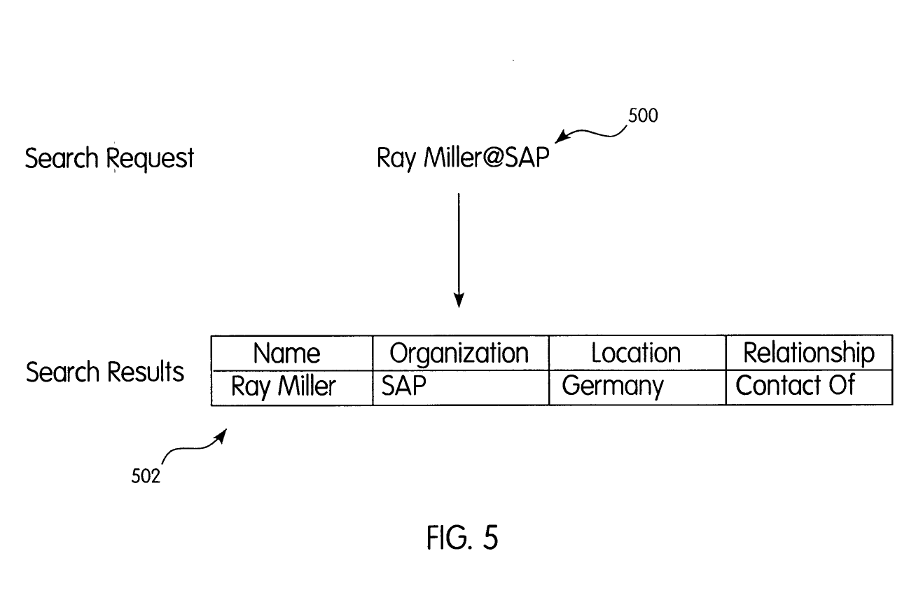

FIG. 5 through FIG. 9 are diagrams of various search results that may be retrieved upon processing of different search requests. The search requests are sent by the computing system 102 shown in FIG. 1A. The corresponding search results are provided to the computing system 102. FIG. 5 shows a search request 500 that contains the characters “Ray Miller@SAP”. In this example, the database system 106 returns a set of search results 502 to the computing system 102 upon processing of this search request. This set of search results 502 includes only one result that matches the name identifiers and relationship specified by the search request 500, and includes corresponding information contained in the name information 108, the relationship information 110, and the additional information 112 stored in the database system 106. The set of search results 502 is sent back to the computing system 102 is a tabular, or structural, form. The search result manager 114 then processes the set of search results 502 and displays them, in graphical form, to a user.

As shown in the example in FIG. 5, the set of search results 502 contains only one listing. The personal name identifier “Ray Miller” matches the first name identifier specified in the search request 500. The organizational name identifier “SAP” matches the second name identifier specified in the search request 500. The relationship “contact of” matches the relationship “@” specified in the search request 500. In this example, it is presumed that the “@” symbol, or character, is used to represent the relationship for “contact of”. The result also shows that “Ray Miller” is located in “Germany”. In the example shown in FIG. 5, the database system 106 was only able to locate one listing that matched the name identifiers and relationship specified in the search request 500. In some embodiments, the set of search results 502 are not displayed in a pop-up window in the computing system 102 when there is only one result. When there are multiple results, such as those shown in subsequent figures, the computing system 102 may display these results in a pop-up window, so that the user may select one of the displayed results.

In an alternate embodiment, the database system 106 may return a different set of search results in response to the search request 500. In this embodiment, if the database system 106 is unable to locate any individuals named “Ray Miller” who are business contacts of “SAP”, then the database system 106 may decide either to return no matching search results to the computing system 102 or, alternatively, to return a broader set of results to the computing system 102. For example, the database system 106 may use a rule-based engine to determine that it will return a set of search results that includes all individuals named “Ray Miller” who are business contacts for any company listed on the database system 106, as specified in the name information 108, the relationship information 110, and/or the additional information 112. Alternatively, the database system 106 may use the rule-based engine to determine that it will return a set of search results that includes all of the business contacts for “SAP”. An administrator may create or modify rules used by the rule-based engine on the database system 106 to manage the processing of search results in these types of instances wherein the database system 106 is unable to identify direct matches to the search request 500 sent by the computing system 102.

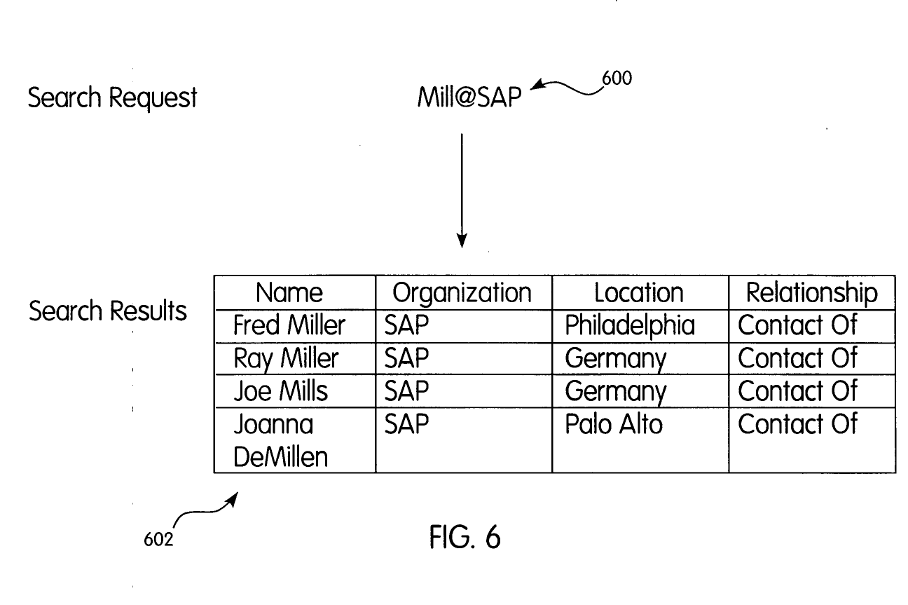

FIG. 6 shows a search request 600 that contains the characters “Mill@SAP”. In this example, the database system 106 returns a set of search results 602 to the computing system 102 upon processing of this search request. This set of search results 602 includes multiple listings that match the name identifiers and relationship specified by the search request 600, and includes corresponding information contained in the name information 108, the relationship information 110, and the additional information 112 stored in the database system 106.

As shown in the example in FIG. 6, the set of search results 602 contains multiple results. Each result includes the name of an individual who is a business contact of the organization, or company, “SAP”, as specified in the search request 600. In this example, it is presumed that the “@” symbol, or character, is used to represent the relationship for “contact of”. Each result also includes name information for an individual whose name includes the characters “Mill”, as specified in the search request 600. The multiple results include names for “Fred Miller”, “Ray Miller”, “Joe Mills”, and “Joanna DeMillen”. These results also include the locations for the various individuals whose names are specified.

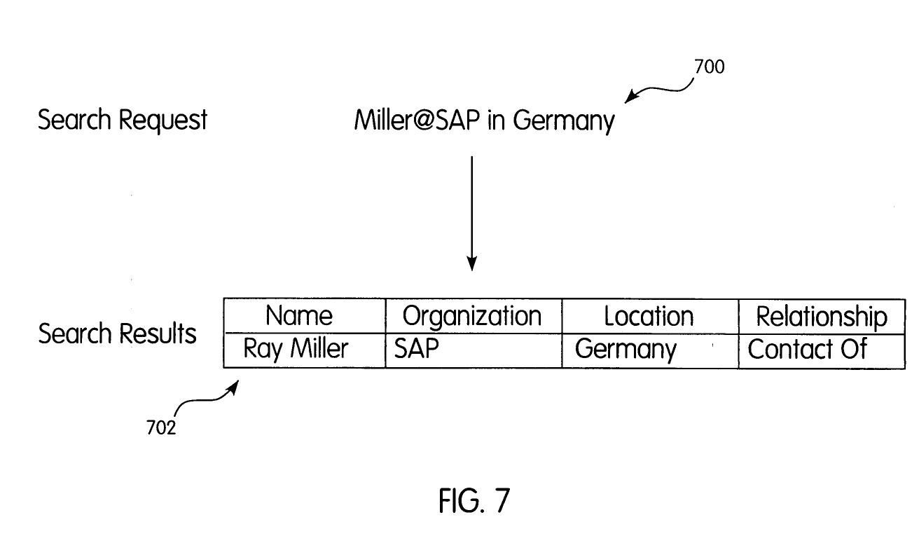

FIG. 7 shows a search request 700 that contains the characters “Miller@SAP in Germany”. In this example, the search request contains three name identifiers and two relations. The search request 700 includes a first name identifier “Miller”, a second name identifier “SAP”, and a third name identifier “Germany”. The search request 700 also includes a first relationship “@” (representing a relationship for “contact of”), and a second relationship “in”. The database system 106 returns a set of search results 702 to the computing system 102 upon processing of this search request. This set of search results 702 includes only one results that matches the name identifiers and relationships specified by the search request 700. In one embodiment, the database system 106 processes the search request from left to right when there are multiple relationships specified. Thus, for the example shown in FIG. 7, the database system 106 may first search for any individuals named “Miller” who are business contacts for the organization “SAP”, and will then search these results for individuals located in “Germany”. The database system 106 may include a rule-based engine (not shown) that determines how to parse and process incoming search requests from the computing system 102 based on a set of predetermined rules. An administrator may modify these rules to change the way in which the database system 106 processes the requests.

As shown in the example in FIG. 7, the set of search results 702 contains only one result. The personal name identifier “Ray Miller” matches the first name identifier specified in the search request 700. The organizational name identifier “SAP” matches the second name identifier specified in the search request 700. The relationship “contact of” matches the first relationship “@” specified in the search request 700. The location identifier “Germany” matches the third name identifier specified in the search request 700, and is also associated with the location relationship specified by the second relationship in the search request 700.

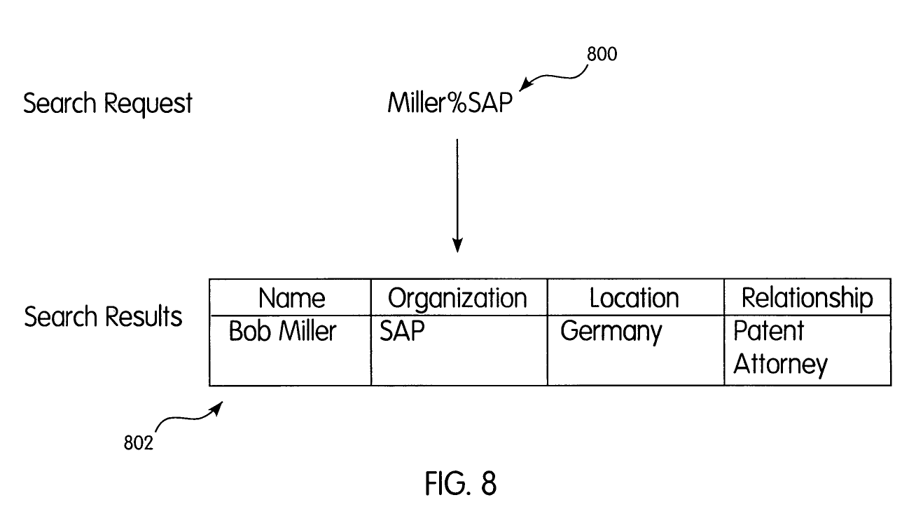

FIG. 8 shows a search request 800 that contains the characters “Miller%SAP”. In this example, the database system 106 returns a set of search results 802 to the computing system 102 upon processing of this search request. This set of search results 802 includes only one result that matches the name identifiers and relationship specified by the search request 800, and includes corresponding information contained in the name information 108, the relationship information 110, and the additional information 112 stored in the database system 106.

As shown in the example in FIG. 8, the set of search results 802 contains only one result. The personal name identifier “Bob Miller” includes the characters “Miller” specified in the first name identifier in the search request 800. The organizational name identifier “SAP” matches the second name identifier specified in the search request 800. The relationship “patent attorney” matches the relationship “%” specified in the search request 800. In this example, it is presumed that the “%” symbol, or character, is used to represent the relationship for “patent attorney”. The result included within the set of search results 802 also shows that “Bob Miller” is located in “Germany”. If there is an individual named “Ray Miller” who is a business contact, but not a patent attorney, for “SAP”, his name will not appear in the set of search results 802, because the search request 800 specifies a relationship of “patent attorney”.

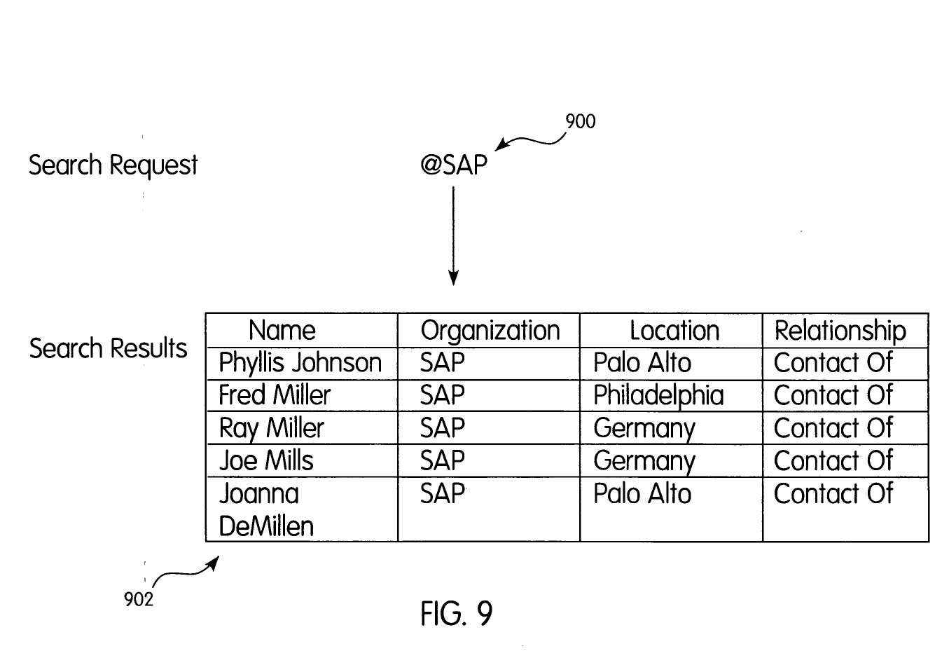

FIG. 9 shows a search request 900 that contains the characters “@SAP”. In this example, the database system 106 returns a set of search results 902 to the computing system 102 upon processing of this search request. This set of search results 902 includes multiple results that match the name identifier and relationship specified by the search request 900, and includes corresponding information contained in the name information 108, the relationship information 110, and the additional information 112 stored in the database system 106.

As shown in the example in FIG. 9, the set of search results 902 contains multiple results. Each result includes the name of an individual who is a business contact of the organization, or company, “SAP”, as specified in the search request 900. In this example, it is presumed that the “@” symbol, or character, is used to represent the relationship for “contact of”. These results also include the locations for the various individuals whose names are specified.

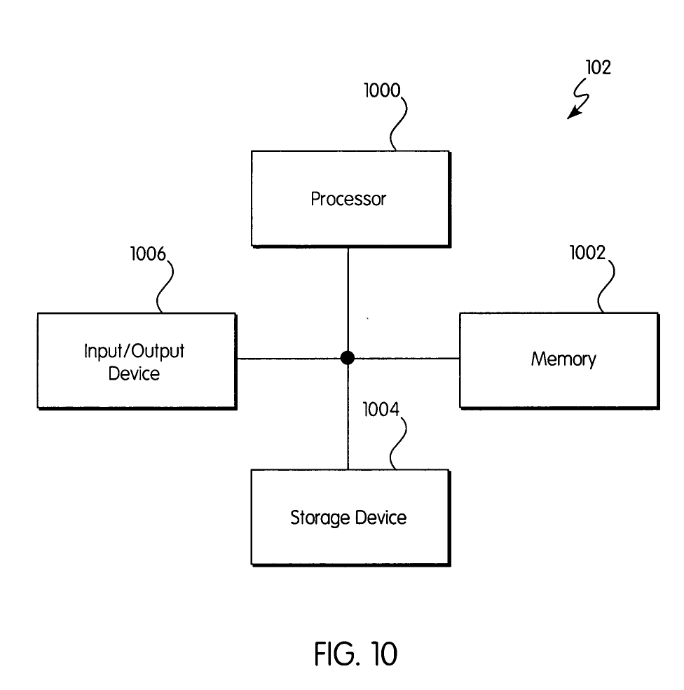

FIG. 10 is a block diagram of the computing system 102 shown in FIG. 1A or FIG. 1B, according to one embodiment. In the example shown in FIG. 10, the computing system 102 includes a processor 1000, a memory 1002, a storage device 1004, and an input/output device 1006. Each of the components 1000, 1002, 1004, and 1006 are interconnected using a system bus. The processor 1000 is capable of processing instructions for execution within the computing system 102. In one embodiment, the processor 1000 is a single-threaded processor. In another embodiment, the processor 1000 is a multi-threaded processor.

The memory 1002 stores information within the computing system 102. In one embodiment, the memory 1002 is a computer- or machine-readable medium. In one embodiment, the memory 1002 is a volatile memory unit. In another embodiment, the memory 1002 is a non-volatile memory unit.

The storage device 1004 is capable of providing mass storage for the computing system 102. In one embodiment, the storage device 1004 is a computer- or machine-readable medium. In various different embodiments, the storage device 1004 may be a floppy disk device, a hard disk device, an optical disk device, or a tape device.

The input/output device 1006 provides input/output operations for the computing system 102. In one embodiment, the input/output device 1006 includes a keyboard and/or pointing device. In one embodiment, the input/output device 1006 includes a display device to display search results to a user.

In some embodiments, the computing system 102 may comprise a handheld or wireless device. In these embodiments, the computing system 102 may include a network adaptor port (not shown) for connecting to an external network device.

A number of embodiments of the invention have been described. Nevertheless, it will be understood that various modifications may be made without departing from the spirit and scope of the invention. Accordingly, other embodiments are within the scope of the following claims.

1. A method to retrieve information that contains name and relationship information, the method comprising:
accepting input from a user to create a search request that contains a plurality of text characters, wherein one or more of the text characters specify a name identifier, and wherein one or more of the text characters specify a relationship to the name identifier;
using the search request to retrieve search results, wherein each search result contains the name identifier, and wherein each search result also contains information representing the specified relationship to the name identifier; and
displaying to the user the name identifier for each search result in textual form.

2. The method of claim 1, wherein the method further comprises displaying to the user information representing the specified relationship to the name identifier for each search result in textual form.

3. The method of claim 1, wherein the method comprises using the search request to retrieve search results from an external database system.

4. The method of claim 3, wherein the external database system contains additional information.

5. The method of claim 1, wherein the method comprises using the search request to retrieve search results from a memory.

6. The method of claim 1, wherein if no search results contain the name identifier and information representing the specified relationship to the name identifier, the method comprises using the search request to retrieve search results that each contain the name identifier.

7. The method of claim 1, wherein one or more of the text characters specify a second name identifier, and wherein the method comprises using the search request to retrieve search results that each contain the second name identifier and information representing the specified relationship between the name identifier and the second name identifier.

8. The method of claim 7, wherein the second name identifier is a personal name identifier, wherein the specified relationship is a contact relationship, and wherein the name identifier is an organizational identifier.

9. The method of claim 7, wherein one or more of the text characters specify a third name identifier, wherein one or more of the text characters specify a second relationship between the second name identifier and the third name identifier, and wherein the method comprises using the search request to retrieve search results that each contain the third name identifier and information representing the second specified relationship between the second name identifier and the third name identifier.

10. The method of claim 7, wherein one or more of the text characters specify a third name identifier, wherein one or more of the text characters specify a second relationship between the first name identifier and the third name identifier, and wherein the method comprises using the search request to retrieve search results that each contain the third name identifier and information representing the second specified relationship between the first name identifier and the third name identifier.

11. The method of claim 10, wherein the third name identifier is a location name identifier, and wherein the second specified relationship is a location relationship.

12. The method of claim 1, wherein the name identifier contains a wildcard character.

13. The method of claim 1, wherein the specified relationship is a working business relationship to the name identifier.

14. The method of claim 1, wherein the specified relationship is a location relationship to the name identifier.

15. The method of claim 1, wherein the name identifier is a location name identifier, an organizational name identifier, or a personal name identifier.

16. A machine-readable medium containing executable instructions contained therein for performing a method to retrieve information that contains name and relationship information, the method comprising:
accepting input from a user to create a search request that contains a plurality of text characters, wherein one or more of the text characters specify a name identifier, and wherein one or more of the text characters specify a relationship to the name identifier;
using the search request to retrieve search results, wherein each search result contains the name identifier, and wherein each search result also contains information representing the specified relationship to the name identifier; and
displaying to the user the name identifier for each search result in textual form.

17. A system for retrieving information that contains name and relationship information, the system being operable to:
accept input from a user to create a search request that contains a plurality of text characters, wherein one or more of the text characters specify a name identifier, and wherein one or more of the text characters specify a relationship to the name identifier;
use the search request to retrieve search results, wherein each search result contains the name identifier, and wherein each search result also contains information representing the specified relationship to the name identifier; and
display to the user the name identifier for each search result in textual form.

18. The system of claim 17, wherein the system is operable to use the search request to retrieve search results from an external database system.

19. The system of claim 17, wherein the system is operable to use the search request to retrieve search results from a memory located within the system.

20. A machine-readable medium containing a data structure contained therein that includes name and relationship information, the data structure comprising:
a first name identifier having one or more text characters;
a second name identifier having one or more text characters; and
a relationship having one or more text characters and being used to specify a relationship between the first and second name identifiers.

21. The machine-readable medium of claim 20, wherein the first name identifier, the second name identifier, and the relationship are all provided in a single text-entry field.

22. The machine-readable medium of claim 20, wherein the first name identifier is a location name identifier, an organizational name identifier, or a personal name identifier.

23. The machine-readable medium of claim 20, wherein the second name identifier is a location name identifier, an organizational name identifier, or a personal name identifier.

24. The machine-readable medium of claim 20, wherein the relationship is a contact relationship or a location relationship.

25. The machine-readable medium of claim 20, wherein the first name identifier contains a wildcard character.

26. The machine-readable medium of claim 20, wherein the second name identifier contains a wildcard character.

27. The machine-readable medium of claim 20, wherein the data structure further comprises:
a third name identifier having one or more text characters; and
an additional relationship having one or more text characters and being used to specify a relationship between the second and third name identifiers.

28. The machine-readable medium of claim 20, wherein the data structure further comprises:
a third name identifier having one or more text characters; and
an additional relationship having one or more text characters and being used to specify a relationship between the first and third name identifiers.
